(19) United States
(12) Patent Application Publication
(10) Pub. No.: US 2010/0098938 A1
(43) Pub. Date: Apr. 22, 2010

(54) METHOD OF PRODUCING A DETACHABLE, ANTI-FOULING COATING

(75) Inventors: Werner Michel, Luetzelbach (DE); Felix Mueller, Velbert (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: Evonik DeGussa, Essen (DE)

(21) Appl. No.: 12/302,817

(22) PCT Filed: May 29, 2007
(86) PCT No.: PCT/EP07/55207

§ 371 Date: Nov. 28, 2008

(30) Foreign Application Priority Data
Jun. 29, 2006 (DE) 10 2006 030 055.6

(51) Int. Cl. B32B 5/00; B05D 1/12; B32B 9/04

(52) U.S. Cl. 428/334; 427/180; 428/447

(57) ABSTRACT

Disclosed is a method of producing a detachable, anti-fouling coating on an article, wherein a preparation comprising nanoscale hydrophobic particles and at least one volatile siloxane is applied to at least one surface of an article and then the volatile siloxane is removed.

The invention relates to a method of producing a detachable, anti-fouling coating, to the coating itself and to its use.

The principle of self-cleaning coatings which are in contact with atmospheric air and on which water acts only occasionally is general knowledge. In order for effective surface self-cleaning to be achieved, these coatings must have not only a highly hydrophobic surface but also a certain roughness. An appropriate combination of structure and water repellency makes it possible for even small amounts of moving water on the surface to entrain adhering dirt particles and clean the surface (WO 96/04123; U.S. Pat. No. 3,354,022).

From EP-A-933388 it is known, moreover, that for self-cleaning surfaces of this kind an aspect ratio of >1 and a surface energy of less than 20 mN/m are required. The aspect ratio here is defined as the ratio of height to the width of the structure. Aforementioned criteria are realized in nature, as for example in the lotus leaf. The surface of the plant, formed from a hydrophobic, wax-like material, has elevations at a distance of a few μm from one another. Water drops come into contact essentially only with the tips of the elevations. Water-repellent surfaces of this kind are described for example in EP-A-909747, WO 00/58410 or U.S. Pat. No. 5,599,489.

A need for surfaces modified in this way exists not only in the case of articles which are surrounded by atmospheric air but also, in particular, in connection with the operation of articles around the whole or part of which water passes, in order to hinder their population by aquatic organisms. These articles may be, for example, walls, container surfaces, bulkheads, breakwaters, posts and other load-bearing constructions which are in long-term contact with either fresh or salt water. The population pressure under water is very great. For instance, there are larvae and spores of around 6000 species of marine bionts known which settle on solid surfaces for the purpose of growing up permanently on them.

The secretions of the adhering organisms may promote the corrosion of the materials. In particular, the contour of a ship's body is altered in such a way by the three-dimensionally projecting infestation that the flow resistance is increased by an average of around 15%, resulting in a higher fuel consumption.

As a remedy, biocidal paints are applied in order to kill or repel the larvae and spores of the unwanted organisms. Included here are coatings which comprise leachable substances that are toxic to aquatic organisms. Such compounds may be organic in nature, such as chlorinated aromatic hydrocarbons such as DDT, for example, or they may be inorganic in nature, such as copper oxide or copper thiocyanate, for example, or else may be organometallic compounds, such as alkyl borates or alkyltin compounds, for example.

A disadvantage of these prior-art biocidal paints is that the substances leached from them, over long periods of time, may contaminate the water and the sediments of the bodies of water and hence may develop unwanted harmful effects. A further disadvantage is that the protective coating present must be removed at regular intervals and replaced by a new coat. This leads to disposal costs for the non-standard waste produced, to costs for the new coating material, and to labour costs.

In order to avoid these disadvantages, there are methods in the prior art which are intended to halt the unwanted biofouling without toxins, on the basis of physical effects. These may be coatings of gel-like silicone polymers on a ship's hull, or the application of a hide-like fabric whose fibres, by virtue of their movements during slow travel, prevent colonization by the larvae.

Although these latter techniques do avoid toxic compounds, they are complicated to produce and apply or, owing to the materials concerned, are expensive, and they therefore remain limited to special cases.

All of these coatings have the disadvantage that they require very large volumes of material and that they are applied to the articles permanently and therefore cannot be simply removed and applied anew again when needed. Renewed application requires in each case that the article be freed from the existing protective coat, which is a costly and inconvenient operation, and that this protective coat be disposed of.

It was an object of the present invention, therefore, to provide a method of producing anti-fouling coatings that allows the surfaces of articles to be treated with a coating which is very thin, which is stable in service and sparing in its use of material, and which is durable yet redetachable by simple means.

The invention provides a method of producing a detachable, anti-fouling coating on an article, wherein a preparation comprising nanoscale hydrophobic particles and at least one volatile siloxane is applied to at least one surface of an article and then the volatile siloxane is removed.

For the purposes of the invention, anti-fouling means that the colonization of the article's surface by mollusks and by algae that grow to a large size is reduced or prevented entirely.

Volatile means that at least 95% of the siloxane has evaporated within 24 hours at 25° C.

Detachable means that the coating obtainable by the method of the invention can be detached from the article again by means of mechanical working such as rubbing, polishing or high-pressure water jet, yet adheres to the article during the envisaged period of use and mode of use.

Nanoscale metal oxide particles are understood to be those having an average diameter of 2 to 100 nm. In the case of aggregated particles, this figure relates to the primary particles present in the aggregate.

The hydrophobic properties of the nanoscale particles may be present inherently, as for example in the case of polytetrafluoroethylene (PTFE). It is also possible, however, to use hydrophobic particles which exhibit hydrophobic properties only after an appropriate treatment.

Nanoscale hydrophobic particles used may be silicates, minerals, metal oxide powders, metal powders, pigments and/or polymers.

It is possible with preference to use nanoscale hydrophobic metal oxide particles.

With particular advantage it is possible to use pyrogenically produced metal oxide particles having a BET surface area of 20 to 400 m²/g and in particular of 35 to 300 m²/g. Pyrogenically produced metal oxide particles for the purposes of the invention encompass aluminium oxide, silicon dioxide, titanium dioxide and/or zinc oxide, and also mixed oxides of the aforementioned compounds.

By pyrogenic, or fumed, metal oxide particles are meant those obtained by flame oxidation and/or flame hydrolysis. In these procedures, oxidizable and/or hydrolysable starting materials are generally oxidized in an oxyhydrogen flame or hydrolysed. Starting materials used for pyrogenic methods may include organic and inorganic substances. Particularly suitable, for example, are the readily available chlorides, such as silicon tetrachloride, aluminium chloride or titanium tetrachloride. Suitable organic starting compounds may for example be alkoxides, such as Si(OC₂H₅)₄, Al(OiC₃H₇)₃ or Ti(OiPr)₄. The resulting metal oxide particles are very largely pore-free and have free hydroxyl groups on the surface. In general the pyrogenic metal oxide particles are at least partly in the form of aggregated primary particles. In the present invention, metalloid oxides, such as silicon dioxide, for example, are termed metal oxide.

The pyrogenic metal oxides acquire their hydrophobic properties through surface modifier reagents which react with active groups on the surface. For this purpose it is possible with preference to use the following silanes, individually or as a mixture:

Organosilanes (RO)₃Si(CₙH₂ₙ₊₁) and (RO)₃Si(CₙH₂ₙ₋₁)

with R=alkyl, such as methyl, ethyl, n-propyl, isopropyl, butyl and n=1-20.

Organosilanes R′ₓ(RO)_{y}Si(CₙH₂ₙ₊₁) and R′ₓ(RO)_{y}Si(CₙH₂ₙ₋₁)

with R=alkyl, such as methyl, ethyl, n-propyl, isopropyl, butyl; R′=alkyl, such as methyl, ethyl, n-propyl, isopropyl, butyl; R′=cycloalkyl; n=1-20; x+y=3, x=1, 2; y=1, 2.

Haloorganosilanes X₃Si(CₙH₂ₙ₊₁) and X₃Si(CₙH₂ₙ₋₁)

with X═Cl, Br; n=1-20.

Haloorganosilanes X₂(R′)Si(CₙH₂ₙ₊₁) and X₂(R′)Si(CₙH₂ₙ₋₁)

with X═Cl, Br, R′=alkyl, such as methyl, ethyl, n-propyl, isopropyl, butyl-; R′=cycloalkyl; n=1-20.

Haloorganosilanes X(R′)₂Si(CₙH₂ₙ₊₁) and X(R′)₂Si(CₙH₂ₙ₋₁)

with X═Cl, Br; R′=alkyl, such as methyl-, ethyl-, n-propyl-, isopropyl-, butyl-; R′=cycloalkyl; n=1-20.

Organosilanes (RO)₃Si(CH₂)ₘ—R′

with R=alkyl, such as methyl-, ethyl-, propyl-; m=0.1-20; R′=methyl, aryl such as —C₆H₅, substituted phenyl radicals, C₄F₉, OCF₂—CHF—CF₃, C₆F₁₃, OCF₂CHF₂, S_{X}—(CH₂)₃Si (OR)₃.

Organosilanes (R″)ₓ(RO)_{y}Si(CH₂)ₘ—R′

with R″=alkyl, x+y=3; cycloalkyl, x=1, 2, y=1, 2; m=0.1 to 20; R′=methyl, aryl, such as C₆H₅, substituted phenyl radicals, C₄F₉, OCF₂—CHF—CF₃, C₆F₁₃, OCF₂CHF₂, Sₓ—(CH₂)₃Si(OR)₃, SH, NR′R″R′″ with R′=alkyl, aryl; R″═H, alkyl, aryl; R′″═H, alkyl, aryl, benzyl, C₂H₄NR″″R′″″ with R″″═H, alkyl and R′″″═H, alkyl.

Haloorganosilanes X₃Si(CH₂)ₘ—R′

X═Cl, Br; m=0.1-20; R′=methyl, aryl such as C₆H₅, substituted phenyl radicals, C₄F₉, OCF₂—CHF—CF₃, C₆F₁₃, O—CF₂—CHF₂, S_{X}—(CH₂)₃Si(OR)₃, where R=methyl, ethyl, propyl, butyl and x=1 or 2, SH.

Haloorganosilanes RX₂Si(CH₂)ₘR′

X═Cl, Br; m=0.1-20; R′=methyl, aryl such as C₆H₅, substituted phenyl radicals, C₄F₉, OCF₂—CHF—CF₃, C₆F₁₃, O—CF₂—CHF₂, —OOC(CH₃)C═CH₂, —Sₓ—(CH₂)₃Si(OR)₃, where R=methyl, ethyl, propyl, butyl and x=1 or 2, SH.

Haloorganosilanes R₂XSi(CH₂)ₘR′

X═Cl, Br; m=0.1-20; R′=methyl, aryl such as C₆H₅, substituted phenyl radicals, C₄F₉, OCF₂—CHF—CF₃, C₆F₁₃, O—CF₂—CHF₂, —S_{X}—(CH₂)₃Si(OR)₃, where R=methyl, ethyl, propyl, butyl and x=1 or 2, SH.

Silazanes R′R₂SiNHSiR₂R′ with R,R′=alkyl, vinyl, aryl.

Cyclic polysiloxanes D3, D4, D5 and their homologues, with D3, D4 and D5 meaning cyclic polysiloxanes having 3, 4 or 5 units of the type —O—Si(CH₃)₂, e.g. octamethylcyclotetra-siloxane=D4.

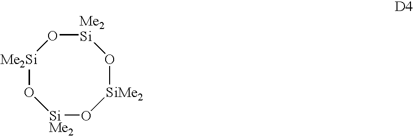

Polysiloxanes or silicone oils of the type

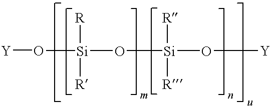

with
R=alkyl,
R′=alkyl, aryl, H
R″=alkyl, aryl
R′″=alkyl, aryl, H
Y═CH₃, H, C_{z}H_{2z+1} with z=1-20,
   Si(CH₃)₃, Si(CH₃)₂H, Si(CH₃)₂OH, Si(CH₃)₂(OCH₃), Si(CH₃)₂(C_{z}H_{2z+1})
where
R′ or R″ or R′″ is (CH₂)_{z}—NH₂ and
z=1-20, m=0, 1, 2, 3, . . . ∞, n=0, 1, 2, 3, . . . ∞, u=0, 1, 2, 3, . . . ∞.

As surface modifiers it is possible with preference to use the following compounds: octyltrimethoxysilane, octyltri-ethoxysilane, hexamethyldisilazane, 3-methacryloyloxy-propyltrimethoxysilane, 3-methacryloyloxypropyltriethoxy-silane, hexadecyltrimethoxysilane, hexadecyltriethoxy-silane, dimethylpolysiloxane, nonafluorohexyltrimethoxy-silane, tridecafluorooctyltrimethoxysilane, tridecafluoro-octyltriethoxysilane.

With particular preference it is possible to use hexamethyldisilazane, octyltriethoxysilane and dimethyl-polysiloxanes.

Suitable hydrophobic, pyrogenic metal oxides can be selected for example from the table of stated AEROSIL® and AEROXIDE® products (all from Degussa).

TABLE
Hydrophobic metal oxides

| | BET | | | |
|---|---|---|---|---|
| | surface | Loss on | | Carbon |
| | area | drying | | content |
| Product | [m²/g] | [wt. %] | pH | [wt. %] |
| AEROSIL ® | | | | |
| R 972 | 110 ± 20 | ≦0.5 | 3.6-4.4 | 0.6-1.2 |
| R 974 | 170 ± 20 | ≦0.5 | 3.7-4.7 | 0.7-1.3 |
| R 104 | 150 ± 25 | — | ≧4.0 | 1.0-2.0 |
| R 106 | 250 ± 30 | — | ≧3.7 | 1.5-3.0 |
| R 202 | 100 ± 20 | ≦0.5 | 4.0-6.0 | 3.5-5.0 |
| R 805 | 150 ± 25 | ≦0.5 | 3.5-5.5 | 4.5-6.5 |
| R 812 | 260 ± 30 | ≦0.5 | 5.5-7.5 | 2.0-3.0 |
| R 816 | 190 ± 20 | ≦1.0 | 4.0-5.5 | 0.9-1.8 |
| R 7200 | 150 ± 25 | ≦1.5 | 4.0-6.0 | 4.5-6.5 |
| R 8200 | 160 ± 25 | ≦0.5 | ≧5.0 | 2.0-4.0 |
| R 9200 | 170 ± 20 | ≦1.5 | 3.0-5.0 | 0.7-1.3 |
| AEROXIDE ® | | | | |
| TiO₂ T805 | 45 ± 10 | — | 3.0-4.0 | 2.7-3.7 |
| TiO₂ NKT90 | 50-75 | — | 3.0-4.0 | 2.0-4.0 |
| Alu C 805 | 100 ± 15 | — | 3.0-5.0 | — |

Volatile siloxanes are all room-temperature liquid linear compounds of the general formula (I) and/or cyclic compounds of the general formula (Ia)

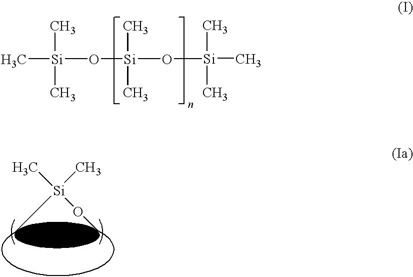

in which n is =a number from 2 to 10.

Preferably n is 2 to 5 for the linear compounds and >4, particularly 5, for the cyclic compounds, such as D5 (decamethylpentacyclosiloxane), for example, and/or 6 to about 8. Cyclic and linear siloxanes can be used in a mixture.

The fraction of the nanoscale hydrophobic particles used in the preparation is preferably 0.5% to 15% by weight, based on the total amount of the solid and liquid constituents of the preparation.

The fraction of siloxane in the preparation is preferably 5% to 99.5% by weight, based on the total amount of the solid and liquid constituents.

The preparation may further comprise a silicone wax, i.e. a polysiloxane with long alkyl chains, which is present in solution in the volatile siloxane.

The silicone wax used may preferably be at least one compound of the general formula (II)

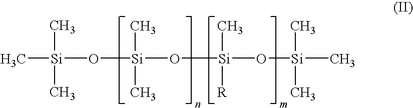

with R=hydrocarbon radical having preferably 10 to 20 carbon atoms, n=2 to 85, m=2 to 60, and the recrystallization points thereof are below about 20° C.

The fraction of the silicone wax used in the preparation is preferably 0.1% to 1% by weight.

For the method of the invention the preparation may further comprise one or more hydrocarbons, esters and ketones, and alcohols that are liquid under standard conditions, having a boiling range of 36° C. to 240° C., preferably of 120° C. to 200° C., alone or in a blend with one another. The concentration of these compounds in the preparation is preferably less than 50% by weight of the total amount of the preparation.

For the method of the invention the preparation may further comprise a propellant gas, such as a butane/propane mixture. Accommodated in a pressurized gas container, this form of the preparation is ideally suited to spray application.

The concentration of hydrophobic particles, based on the total liquid volume in the pressurized container, is 1 to 200 g/l, preferably 10 to 50 g/l.

The application of the preparation to at least one surface of an article can be accomplished in any way known to a person skilled in the art. With preference the preparation is applied by immersing the article in the preparation, by roller application using a fleece roller, or by spray application of the preparation to the article.

The spray application of the preparation may be accomplished by means of a spraying apparatus having a nozzle with a diameter of 0.05 to 2 mm, preferably with a diameter of 0.1 to 0.9 mm. The spraying of the preparation can be accomplished preferably with a pressure of 1 to 5 bar.

The volatile siloxane is removed by evaporation or volatilization, which can be accelerated by the use of elevated temperatures, by air movement or by the use of sub-atmospheric pressure or vacuum.

The method of the invention can be used to produce articles treated on at least one surface with an anti-fouling coating.

The article to be coated may be made, for example, of metal, plastic, wood, ceramic or glass.

The invention further provides a detachable, anti-fouling coating on an article, obtainable by the method of the invention.

One feature of the coating of the invention is that it is initially not fully wetted by water. Instead, a ternary solid/liquid/gaseous phase boundary exists. After a certain dwell time, this phase boundary undergoes transition to a fully wetted state. After that there is only a solid/liquid phase boundary. This remains in existence, even if the coated article is brought temporarily into contact with a gas phase, air for example.

A further feature of the coating of the invention is that it can be redetached from the article by mechanical working such as rubbing, polishing or high-pressure water jet, but otherwise adheres to the article firmly enough to maintain its service properties over a long period of several months. It is therefore especially suitable as a protective coating for articles which are maintained at periodic intervals.

The coating of the invention preferably has a thickness of 0.1 to 100 μm. Particular preference may be given to values of 1 μm to 50 μm.

Furthermore, the coating of the invention preferably has a concentration of the nanoscale hydrophobic particles of 0.01 to 5 g/m². Particular preference may be given to values of 0.1 to 0.5 g/m².

The invention further provides for the use of the coating of the invention for the biostatic treatment of surfaces in contact with water.

The invention has the advantage that articles of all kinds can be treated with an anti-fouling, physiologically unobjectionable, non-permanent coat in a simple way.

In contrast to prior-art methods, the coating of the invention with a detachable coat is very mild, since there is no need to use objectionable or aggressive solvents and the coating can be detached, for example, mechanically, such as by rubbing.

The coating produced by means of the method of the invention is non-permanent and is therefore especially suitable as a protective coating for articles that are maintained at periodic intervals.

The method of the invention and its use are described exemplarily below, without any intention that the invention be restricted thereto.

### EXAMPLES

### Example 1

2.0 g of AEROSIL R 812S are dispersed with intense stirring in 98.0 g of decamethylcyclopentasiloxane (D5).

### Example 2

0.5 g of siloxane wax (Tegopren® 6814) having a molecular weight of 13 000 g/mol and a recrystallization point of <5° C. was dissolved in 97.5 g of decamethylcyclopentasiloxane (D5). 2.0 g of AEROSIL R 812S are dispersed with intense stirring in this solution.

Test procedure: The preparations of Examples 1 and 2 are applied to sections of the underwater hull of a sailing boat. The application rate is such that there is on average 0.25 g of the hydrophobicized silicon dioxide per m² of coated area. Immediately after application, the coatings of Examples 1 and 2 are completely water-repellent. The boat is placed in water and remains for 3.5 months in the Baltic Sea water. After this time it is brought onto land and inspected for infestation by marine organisms.

It is found that the entire area treated is fully wetted. The zones coated with the preparations of Examples 1 and 2 are coated with a thin green algal layer of about one millimetre, which is very easily removable by wiping. There are only very sporadic, small deposits of barnacles or mussels apparent.

1. A method of producing a detachable, anti-fouling coating on an article, wherein a preparation comprising nanoscale hydrophobic particles and at least one volatile siloxane is applied to at least one surface of an article and then the volatile siloxane is removed.

2. The method according to claim 1, wherein the nanoscale hydrophobic particles are metal oxide particles having a BET surface area of 10 to 400 m²/g.

3. The method according to claim 2, wherein the particles are pyrogenically produced metal oxide particles.

4. The method according to claim 1, wherein the volatile siloxane comprises at least one compound of the general formula (I) and/or cyclic compounds of the general formula (Ia), with n=2 to 10.

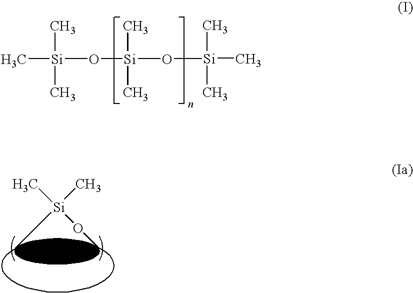

5. The method according to claim 1, wherein the fraction of nanoscale hydrophobic particles is 0.5% to 15% by weight, based on the total amount of the solid and liquid constituents of the preparation.

6. The method according to claim 1, that wherein the preparation further comprises a silicone wax present in solution in the volatile siloxane.

7. The method according to claim 6, wherein the silicone wax is at least one compound having the general formula (II), with R=hydrocarbon radical, n=2 to 85, m=2 to 60, and the silicone wax has a recrystallization point of below 20° C.

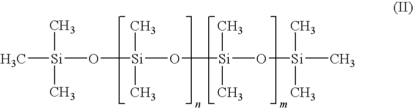

8. The method according to claim 6, wherein the fraction of silicone wax in the preparation is 0.1% to 1% by weight.

9. The method according to claim 1, wherein the preparation is applied to the article by spraying.

10. A detachable, anti-fouling coating on an article, produced by the method according to claim 1.

11. The coating according to claim 10, wherein the thickness is 0.1 to 100 μm.

12. The coating according to claim 10, wherein the concentration of the nanoscale hydrophobic particles in the coating is 0.01 to 5 g/m².

13. A method for the biostatic treatment of surfaces in contact with water comprising applying to said surfaces the coating according to claim 10.
